(19) United States
(12) Patent Application Publication
(10) Pub. No.: US 2025/0295058 A1
(43) Pub. Date: Sep. 25, 2025

(54) SPRAYING SYSTEM COMPRISING A NOZZLE HOLDER WITH A VIBRATION SENSOR

(71) Applicant: EXEL INDUSTRIES, EPERNAY (FR)

(72) Inventor: Sylvain PITAUD, CHANEINS (FR)

(73) Assignee: EXEL INDUSTRIES, EPERNAY (FR)

(21) Appl. No.: 19/074,561

(22) Filed: Mar. 10, 2025

(30) Foreign Application Priority Data
Mar. 25, 2024 (FR) 2402971

(51) Int. Cl. A01C 23/04; A01C 23/00; B05B 12/00

(52) U.S. Cl. CPC A01C 23/047; A01C 23/007; B05B 12/004

(57) ABSTRACT

The present invention relates to a spraying system for an agricultural sprayer, comprising a spray boom having a nozzle holder comprising a body housing a spray product inlet duct configured to be supplied with spray product, a nozzle for said product comprising an outlet orifice for said product and configured to be supplied with product via the inlet duct and to convey said product towards said outlet orifice, a vibration sensor; said boom being configured to spray product through said nozzle; said sensor being configured to measure the vibrations of the body, said spraying system further comprising a computing unit configured to compare the vibration measurement with a reference signal to determine the clog state of said nozzle.

### TECHNICAL FIELD

The present invention relates to the field of agricultural spraying systems. More precisely, the invention concerns a spray boom, comprising at least one spray nozzle and a vibration sensor measuring the vibration of a fluid passing through said nozzle.

### STATE OF THE ART

An agricultural spray boom generally comprises nozzle holders distributed uniformly along the length of the spray boom, for spraying crop protection products onto rows of plants, in liquid form or as liquid fertilizer, for example. In particular, such a known spray boom is designed to spray liquid onto the field.

As is well known, a spray boom thus comprises a plurality of nozzles spaced apart from one another, said spacing being fixed and the nozzles enabling a double or even triple coverage of the surface sprayed by the liquid. A known spray boom allows the entire field to be sprayed, rather than spraying in rows.

The sprayed crop protection product has a certain viscosity and a build-up of suspended deposits during spraying. Thus, during spraying, the spray nozzles may become totally or partially clogged, preventing spraying, or at least making it less homogeneous, by preventing the spraying of certain areas of the planted rows or leading to restricted spraying.

Furthermore, the risk of at least partial clogging of the spray nozzles causes considerable stress for the user, who has to check that the spray nozzles are working properly throughout the spraying operation to ensure good that it was sprayed properly, in particular by frequently turning around to observe the spray condition of the nozzles in order to quickly detect any clogged spray nozzles.

The invention aims to resolve the above-mentioned drawbacks of the prior art, in particular by proposing a spray boom comprising at least one nozzle holder enabling the condition of the nozzles to be measured, that is, whether they are spraying correctly or whether they are at least partially clogged, and warning the user when this is the case.

### PRESENTATION OF THE INVENTION

More specifically, the invention relates to a spraying system for an agricultural sprayer, comprising a spray boom having a main duct and at least one nozzle holder connected to the main duct. The nozzle holder comprises a body housing a spray inlet duct configured to be supplied with spray via said main duct. The nozzle holder comprises at least one first nozzle for spraying said product, comprising at least one outlet orifice for said product and configured to be supplied with product via the product inlet duct and to convey said product towards said outlet orifice. The nozzle holder has at least one vibration sensor housed in said body or connected to said first nozzle. Said spray boom is configured to spray product through said first spray nozzle, said vibration sensor being configured to measure vibrations of the body. Said spraying system further comprises a computing unit configured to compare the measurement of the vibrations of the body or first nozzle with a reference signal to determine the clog state of said nozzle.

The spray product is conveyed from the main duct to the nozzle outlet via the inlet duct of the nozzle holder. When the spray nozzle that sprays out the product is partially clogged, disruptions are generated in the product flow, causing vibrations in the body of the nozzle holder. The vibration sensor then measures the vibrations generated in the body and compares them with a reference signal. When the vibrations generated exceed the reference signal, the nozzle is partially blocked. When vibrations tend towards zero, the nozzle is completely blocked. The spraying system can therefore inform the user about the clog state of the nozzles, without having to constantly turn towards them, and check that each nozzle is spraying the crop protection product correctly.

Advantageously, the vibration sensor is a piezoelectric sensor.

Advantageously, the vibration sensor is housed in the body of the nozzle holder, in the vicinity of the outlet orifice of said nozzle.

This location, as close as possible to the nozzle outlet orifice, enables the most accurate possible measurement of body vibrations and, in particular, of the noise generated by the discharge of the spray product through the nozzle outlet orifice.

Advantageously, the vibration sensor is further configured to convert the vibration measurement into an electrical signal.

Advantageously still, the vibration sensor is further configured to convert the electrical signal into a differential signal.

Advantageously still, said vibration sensor is configured to send the signal, if need be a differential one, to the computing unit which is configured to compare said signal with a predetermined threshold signal.

Advantageously, the nozzle holder comprises a plurality of spray nozzles, the vibration sensor being configured to measure the vibrations of the body of each of the nozzles and to determine the clog state of each of the nozzles.

Advantageously, the nozzle holder comprises a plurality of spray nozzles, a vibration sensor being connected to each of the nozzles and being configured to measure the vibrations of each of the nozzles and determine their clog state.

Advantageously, the spraying system comprises a vibration amplification device located upstream of the spray nozzle outlet orifice, said amplification device being configured to amplify the vibrations of the body or nozzle.

Such amplifying devices increase body vibrations when the spray nozzle becomes blocked. As a result, measurement by the vibration sensor is more reliable.

According to a first embodiment, the amplification device comprises propellers with blades configured to rotate in the spray product, so as to disrupt the flow of spray product passing through the nozzle.

As a result, the flow of liquid through the nozzle vibrates more than if it had not been disrupted, generating more vibrations and therefore more noise. The sensor therefore measures larger vibrations.

According to a second variant, the amplification device comprises protuberances projecting from the walls of the body, in the direction of the spray product passing through it, and configured to disrupt said product.

The protuberances are configured to deflect the flowing spray product in several directions and thus disrupt it, increasing vibrations in the body and thus increasing the noise generated.

Advantageously, the spraying system further comprises a second sensor configured to measure the ambient noise of the spraying system, so that the measurement made by the vibration sensor can be compared with the measurement made by said second sensor.

According to another aspect of the invention, it relates to a method for detecting the clogging of at least one nozzle of a spraying system as previously described, comprising at least the following steps:
a step consisting in passing the spray product through an orifice of said nozzle;
a step consisting in measuring the vibrations of the nozzle body by means of a vibration sensor;
a step consisting in converting the vibration measurement into an electrical signal;
an optional step consisting in converting said amplified electrical signal into a differential signal, by means of a board integrated into said vibration sensor;
a step consisting in transporting said electrical signal, if necessary converted into a differential signal, to a computing unit of the spraying system;
a step consisting in comparing said electrical signal, if necessary converted into a differential signal, with a reference signal.

The method according to the invention may further comprise a step of measuring the ambient noise, before or after the step consisting in passing the spray product through an orifice of the nozzle, the measurement of the ambient noise being filtered from the measurement of the vibrations of the nozzle body.

Advantageously, a step consisting in amplifying the electrical signal is interposed between said step consisting in converting the vibration measurement into an electrical signal and said step consisting in converting said amplified electrical signal into a differential signal, by means of a board integrated into said vibration sensor.

According to a first embodiment, the reference signal is a predetermined threshold value pre-recorded in said computing unit.

When the measured noise exceeds the predetermined threshold value, the nozzle is partially clogged. When the measured noise tends towards zero, the nozzle is completely blocked.

According to a second embodiment, the reference signal corresponds to a calibrated threshold signal at the start-up of said at least one spray nozzle.

In this embodiment, the noise measured by the sensor is compared with a calibrated threshold signal. When the measured noise exceeds the calibrated threshold signal, the nozzle is partially clogged. When the measured noise tends towards zero, the nozzle is completely blocked.

According to a third embodiment, wherein the spray boom comprises a plurality of spray nozzles and wherein the reference signal corresponds to an average of the electrical signals, possibly converted into differential signals, conveyed from the other spray nozzles.

In this embodiment, the noise measured by the sensor is compared with an average of the noise generated by the other nozzles in the spray boom. When the measured noise exceeds the average of the other nozzles, the nozzle is partially clogged. When the measured noise tends towards zero, the nozzle is completely blocked.

### PRESENTATION OF THE FIGURES

The invention will be better understood upon reading the following description, given by way of example, and referring to the following figures, given as non-limiting examples, wherein identical references are given to similar objects, and wherein:

FIG. 1 is a schematic perspective view of a nozzle holder according to the invention, comprising a main duct to which is connected the body of the nozzle holder comprising four spray nozzles and at least one vibration sensor;

FIG. 2 is a left-hand schematic of the nozzle holder shown in FIG. 1 from which a cover of the nozzle holder body has been removed, revealing the vibration sensor circuit board; and

FIG. 3 is a flow chart showing the method for detecting the clogging of at least one nozzle on the spray boom nozzle holder shown in FIG. 1.

It should be noted that the figures set forth the invention in detail to implement the invention; although non-limiting, said figures of course being capable of being used to further define the invention where appropriate.

### DETAILED DESCRIPTION OF THE INVENTION

The invention relates to a crop protection spraying system for an agricultural sprayer. In particular, the spray product is in liquid form or liquid fertilizer form with a certain viscosity. A clump of suspended deposits may form during spraying.

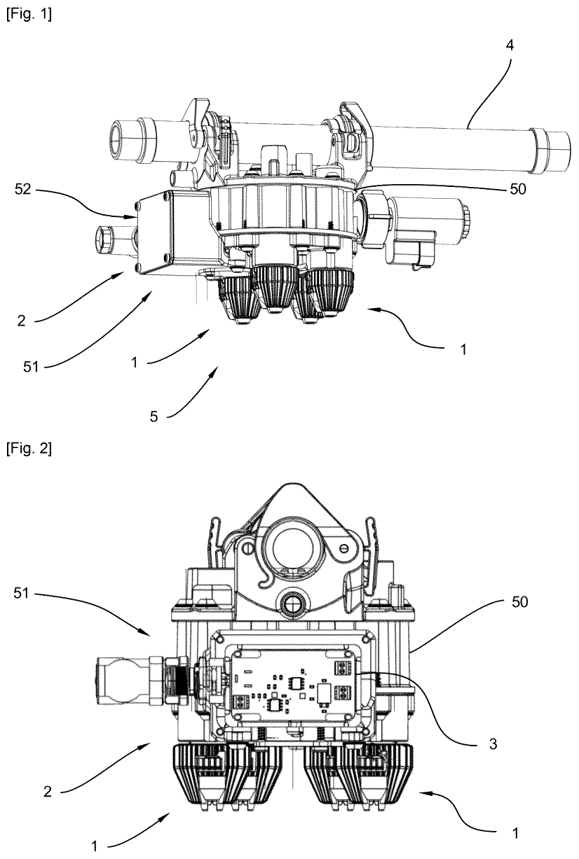

The spraying system shown in FIGS. 1 and 2 comprises a spray boom.

The spray boom is configured to spray crop protection agent onto rows of vegetation.

The spray boom comprises a main duct 4 and at least one nozzle holder 5 connected to the main duct 4.

The nozzle holder 5 comprises a body 50 housing an inlet duct for the crop protection agent to be sprayed. The inlet duct is configured to be supplied with product via the main duct 4.

The nozzle holder 5 further comprises at least one first nozzle 1, advantageously a plurality of nozzles 1, having a product outlet orifice and configured to be supplied with product via the product inlet duct and to convey it to the outlet orifice.

Referring to FIG. 1, the nozzle holder 5 here has four spray nozzles 1.

The nozzle holder 5 has at least one vibration sensor 2. The vibration sensor 2 is housed in the body 50 of the nozzle holder 5.

The nozzle holder 5 with a plurality of nozzles 1 may comprise a sensor at each orifice of each nozzle.

The vibration sensor 2 comprises at least one electronic board 3. The electronic board 3 is housed in the body 50 of the nozzle holder 5.

According to a variant not shown, the electronic board can be offset from the body 50 of the nozzle holder 5.

In particular, the body 50 of the nozzle holder 5 has a chamber 51, the side walls of which delimit an opening. The sensor 2 is inserted through said opening and connected to the body 50. The chamber 51 is closed by a cover 52, visible in FIG. 1. In FIG. 2, the cover 52 has been removed to reveal the sensor 2.

The sensor 2 is configured to measure the vibrations of the body 50.

In particular, the sensor 2, housed in the body 50 and more precisely in the chamber 51, is located in the vicinity of the outlet of the nozzle 1 of the nozzle holder 5.

According to one variant, the sensor 2 is housed at the junction between the spray boom and the nozzle holder 5, so that there is only one sensor 2 for a plurality of nozzles 1.

This location, as close as possible to the nozzle outlet orifice, enables the most accurate possible measurement of vibrations of the body 50 and, in particular, of the noise generated by the discharge of the spray product through the outlet orifice of the nozzle 1.

The greater the measured vibrations of the body 50, the greater the noise generated by the discharge of the spray product through the outlet orifice of the nozzle 1.

When the nozzle 1 is partially clogged, the vibrations of the body 50 are large and the noise generated is also considerable.

When nozzle 1 is completely clogged, the vibrations of the body 50 cease and no more noise is generated.

The vibration sensor 2 can also be configured to convert the vibration measurement into an electrical signal, if necessary to amplify said electrical signal, and optionally to convert it into a differential signal.

Advantageously, the sensor 2 is a piezoelectric sensor.

The spraying system further comprises a computing unit configured to compare the measurement of the vibrations of the body 50 with a reference signal to determine the clog state of the spray nozzle 1.

The sensor 2, configured to measure the vibrations of the body 50, enables the computing unit to determine the clog state of each of the nozzles 1 when the nozzle holder omprises a plurality of nozzles, as shown in the example in the figures.

The vibration sensor 2 is configured to measure the vibrations of the body 50 of each of the nozzles 1 and to determine the clog state of each of the nozzles 1.

In particular, the vibration sensor 2 is configured to send the electrical signal, which may be converted into a differential signal, to the computing unit, which in turn is configured to compare said differential signal transported with a predetermined threshold signal.

According to a particular embodiment of the invention, the spraying system further comprises a second sensor configured to measure the ambient noise of the spraying system. The measurement made by the vibration sensor 2 can then be compared with the measurement made by the second sensor, enabling precise measurement of the vibration of the body 50 of the nozzle holder 5. In particular, the measurement of the second sensor enables only ambient noise to be detected, and therefore filtered out from the measurement of the first sensor 2, so that only the vibrations of the body 50 are measured. To this end, the measurement of the ambient noise is deduced, for example, from the measurement of the vibrations of the body 50 of each nozzle 1. According to an embodiment, in this case, the measurement taken by the second sensor can be taken even before the spraying system is started, that is, before any sprayed product passes through the orifice of the nozzle 1 or nozzles 1.

The second sensor is arranged on the spraying system, in particular on the spray boom, and in particular at a distance from the first sensor, so as to pick up ambient noise from the spray boom, such as the noise of the agricultural machinery engine, for example, but without picking up the noise generated by the spraying of the crop protection agent through the spray nozzles.

Advantageously, the second sensor is a piezoelectric sensor.

For example, the second sensor is configured to measure the signal corresponding to the noise generated by a PWM coil controlling the opening and closing of nozzles 1 and/or to measure the signal corresponding to the noise generated by a device motorizing a multi-nozzle holder carrying a set of nozzles 1.

According to an embodiment of the invention, the spraying system comprises a noise amplification device. The vibration amplification device is configured to amplify the vibrations of the body 50 and in particular the noise generated by the exit of the spray product through the outlet orifice of the nozzle 1.

The amplification device is located in the body 50 of the nozzle holder 5. In particular, the amplification device is located upstream of the outlet orifice of the nozzle 1.

Alternatively, it can be positioned at the junction between the spray boom and the nozzle holder 5, so that there is only one amplification device for a plurality of nozzles 1.

The amplification device may, for example, comprise propellers whose blades are configured to rotate in the spray product, so as to disrupt the flow of liquid passing through the nozzle 1. As a result, the liquid passing through the nozzle 1 vibrates more than if it had not been disrupted, thus generating more noise. The sensor 2 therefore measures larger vibrations.

The amplification device may further comprise propellers, at least a portion of the blades of which are helical. The blades are configured to rotate in the spray product, so as to disrupt the flow of liquid passing through the nozzle 1. As a result, the liquid passing through the nozzle 1 vibrates more than if it had not been disrupted, thus generating more noise. The sensor 2 therefore measures larger vibrations.

The amplification device may also feature protuberances protruding from the walls of the body 50, in the direction of the spray medium passing through it. The protuberances are configured to deflect the flowing product in several directions and thus disrupt it, increasing vibrations in the body 50 and thus increasing the noise generated.

The amplification device may further comprise a vibrating reed corresponding to a lamella configured to vibrate, a static mixer, a flexible membrane, or any other means of achieving the same effect.

In particular, such amplifying devices increase the vibrations of the body 50 when the spray nozzle 1 becomes blocked.

The invention also relates to a method for detecting the clogging of at least one nozzle 1 of the spraying system as previously described.

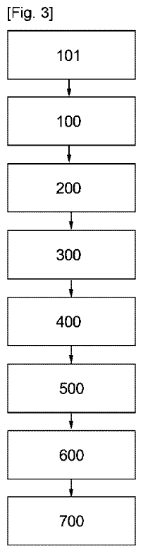

Referring to FIG. 3, the detection method comprises a step 100 consisting in passing the spray product through the outlet orifice of the nozzle 1.

In particular, the spray product is conveyed into the main duct 4 (FIG. 1), then into the nozzle holder 5, through the body 50 of the nozzle holder 5, towards the spray nozzle(s) 1, then through the spray nozzle(s) 1 to their outlet orifice, and then sprayed outwards through the outlet orifice.

The method then comprises a step 200 consisting in measuring the vibrations of the body 50 of the nozzle 1 or nozzles 1, by means of the vibration sensor 2.

Next, the method comprises a step 300 consisting in converting the measurement of the vibrations of the body 50 from step 200 into an electrical signal.

The method then comprises an optional step 400 consisting in amplifying the electrical signal generated in step 300. This step is implemented in a preferred embodiment of the method according to the invention.

In the particular embodiment in which the spraying system comprises a second sensor for measuring the ambient noise, the detection method may comprise a step 101, during which the second sensor measures the ambient noise. In particular, step 101 can be implemented prior to step 100, that is, even before the spraying system is started, that is, before any sprayed material passes through the orifice of nozzle 1 or nozzles 1. Alternatively, measurement by the vibration sensor 2 and measurement of ambient noise by the second sensor can be carried out at the same time, for example. The measurement of ambient noise is used to filter out the ambient noise from the measurement made by the vibration sensor 2. In this case, the second sensor is preferably arranged at a point on the spraying system, particularly on the spray boom, remote from the vibration sensor 2.

An optional step 500 consists in converting said amplified electrical signal into a differential signal, by means of the electronic board 3 integrated into the vibration sensor 2. Converting the electrical signal into a differential signal improves the efficiency of the method. However, this step is optional.

A step 600 consists in transporting the electrical signal, if necessary converted into a differential signal, to the computing unit of the spraying system.

A step 700 consists in comparing said transported electrical signal, if necessary converted into a differential signal, with a reference signal.

According to a first embodiment, the reference signal is a predetermined threshold value pre-recorded in said computing unit.

In this embodiment, the noise measured by the sensor 2 is compared with a predetermined threshold value. When the measured noise exceeds the predetermined threshold value, the nozzle 1 is partially clogged. When the measured noise tends towards zero, the nozzle 1 is completely blocked.

According to a second embodiment, the reference signal corresponds to a calibrated threshold signal at the start-up of the spray nozzle 1.

In this embodiment, the noise measured by the sensor 2 is compared with a calibrated threshold signal. When the measured noise exceeds the calibrated threshold signal, the nozzle 1 is partially clogged. When the measured noise tends towards zero, the nozzle 1 is completely blocked.

According to a third embodiment, the reference signal corresponds to an average of the electrical signals, possibly converted into differential signals, conveyed from the other spray nozzles 1.

In this embodiment, the noise measured by the sensor 2 is compared with an average of the noise generated by the other nozzles 1 in the spray boom. When the measured noise exceeds the average of the other nozzles, the nozzle 1 is partially clogged. When the measured noise tends towards zero, the nozzle 1 is completely blocked.

More generally, the reference signal, which may or may not be pre-recorded in the system, may depend on spray parameters such as the speed of travel of the spraying system, the flow rate of the sprayed product, or the pressure of the sprayed product circulating through the spray boom of the spraying system. In this way, the computing unit can be configured to automatically adjust the reference signal taken into consideration, so as to adapt it to the spray parameters or to one of the spray parameters. For example, if the speed or flow rate of the sprayed product or the pressure of the sprayed product flowing through the spray boom of the spraying system changes, then the reference signal changes accordingly.

According to the invention, detecting the clogging of a nozzle 1 enables a signal to be generated to warn the user of the potential clogging of one or more spray nozzles. The suspected clogging of at least one nozzle 1 can take the form of a sound or light signal, for example.

It should also be noted that the invention is not limited to the embodiments described above. Indeed, it will become apparent to the person skilled in the art that various modifications can be made to the above-described embodiment, in the light of the teachings just disclosed.

In the detailed presentation of the invention given above, the terms used should not be interpreted as limiting the invention to the embodiment set out in the present description, but should be construed to include all equivalents the anticipation of which is within the abilities of a person skilled in the art by applying his general knowledge to the implementation of the teaching just disclosed to them.

1. A spraying system for an agricultural sprayer, comprising a spray boom having a main duct and at least one nozzle holder connected to the main duct, the nozzle holder comprising:
a body housing a spray product inlet duct configured to be supplied with spray product via said main duct;
at least one first nozzle for spraying said product, comprising at least one outlet orifice for said product and configured to be supplied with product via the product inlet duct and to convey said product towards said outlet orifice;
at least one vibration sensor housed in said body or connected to said nozzle;
said spray boom being configured to spray product through said first spray nozzle;
said vibration sensor being configured to measure the vibrations of the body;
the spraying system further comprising a vibration amplification device located upstream of the spray nozzle outlet orifice, said amplification device being configured to amplify the vibrations of the body or nozzle; and
said spraying system further comprises a computing unit configured to compare the measurement of the vibrations of the body or nozzle with a reference signal to determine the clog state of said nozzle.

2. The spraying system according to claim 1, wherein the vibration sensor is a piezoelectric sensor.

3. The spraying system according to claim 1, wherein the vibration sensor is housed in the body of the nozzle holder, in the vicinity of the outlet orifice of said nozzle.

4. The spraying system according to claim 1, wherein the vibration sensor is further configured to transform the vibration measurement into an electrical signal.

5. The spraying system according to claim 4, wherein the vibration sensor is further configured to transform the electrical signal into a differential signal.

6. The spraying system according to claim 5, wherein said vibration sensor is configured to send the differential signal to the computing unit which is configured to compare said differential signal with a predetermined threshold signal.

7. The spraying system according to claim 1, wherein the nozzle holder comprises a plurality of spray nozzles, the vibration sensor being configured to measure the vibrations of the body of each of the nozzles and to determine the clog state of each of the nozzles.

8. The spraying system according to claim 1, wherein the nozzle holder comprises a plurality of spraying nozzles, a vibration sensor being connected to each of the nozzles and being configured to measure the vibrations of each of the nozzles and determine their clog state.

9. The spraying system according to claim 1, wherein the amplification device comprises propellers comprising blades configured to rotate in the spray product, so as to disrupt the flow of spray product passing through the nozzle.

10. The spraying system according to claim 1, wherein the amplification device comprises protuberances projecting from the walls of the body, in the direction of the spray product passing through it and configured to disrupt said product.

11. The spraying system according to claim 1, further comprising a second sensor configured to measure the ambient noise of the spraying system, so that the measurement made by the vibration sensor can be compared with the measurement made by said second sensor.

12. A method for detecting the clogging of at least one nozzle of a spraying system according to claim 1, comprising at least the following steps:
a step consisting in passing the spray product through an orifice of said nozzle;
a step consisting in measuring the vibrations of the nozzle body by means of a vibration sensor;
a step consisting in converting the vibration measurement into an electrical signal;
an optional step consisting in converting said amplified electrical signal into a differential signal, by means of a board integrated into said vibration sensor;
a step consisting in transporting said electrical signal, eventually converted into a differential signal, to a computing unit of the spraying system;
a step consisting in comparing said transported electrical signal, if necessary converted into a differential signal, with a reference signal.

13. The detection method according to claim 12, comprising a step of measuring the ambient noise, in particular prior to the step consisting in passing the spray product through an orifice of the said nozzle, the measurement of the ambient noise being filtered from the measurement of the vibrations of the body of the nozzle.

14. The detection method according to claim 12, wherein a step consisting in amplifying the electrical signal is interposed between said step consisting in converting the vibration measurement into an electrical signal and said step consisting in converting said amplified electrical signal into a differential signal, by means of a card integrated into said vibration sensor.

15. The detection method according to claim 12, wherein the reference signal is a predetermined threshold value pre-stored in said computing unit.

16. The detection method according to claim 12, wherein the reference signal corresponds to a threshold signal calibrated at the start-up of said at least one spray nozzle.

17. The detection method according to claim 12, wherein the spray boom comprises a plurality of spray nozzles and wherein the reference signal corresponds to an average of the electrical signals, optionally converted into differential signals, conveyed from the other spray nozzles.

18. The detection method according to claim 17, wherein the electrical signals are converted beforehand into differential signals.
